(19) United States
(12) Patent Application Publication
(10) Pub. No.: US 2022/0011740 A9
(43) Pub. Date: Jan. 13, 2022

(54) Energy consumption prediction system and method based on the decision tree for CNC lathe turning

(71) Applicant: Jiangnan University, Wuxi (CN)

(72) Inventors: Yan WANG, Wuxi (CN); Lijun CHENG, Wuxi (CN); Zhicheng JI, Wuxi (CN); Jiqiang ZHAO, Wuxi (CN); Zhenyu ZHU, Wuxi (CN)

(21) Appl. No.: 16/724,452

(22) Filed: Dec. 23, 2019

Related U.S. Application Data
(63) Continuation of application No. PCT/CN2018/089614, filed on Jun. 1, 2018.

(30) Foreign Application Priority Data
Jun. 26, 2017 (CN) 201710498588.1

(51) Int. Cl. G05B 19/4063; G05B 19/18; G06K 9/62; G06N 3/08

(52) U.S. Cl. CPC G05B 19/4063; G05B 19/182; G05B 2219/35215; G06N 3/08; G06K 9/6256

(57) ABSTRACT

The present disclosure discloses a system and a method for predicting energy consumption in a numerically controlled lathe turning process based on a decision tree and belongs to the technical field of lathe control systems. According to the present disclosure, the energy consumption in the turning process of the numerically controlled lathe turning process based on mass historical data generated in the turning process, and the limit of specific workshop environmental factors such as lathe types and workpiece machining methods on a traditional energy consumption prediction algorithm is broken through; and the influence of various factors on turning energy consumption of a numerically controlled lathe is fully considered, a quantitative relationship between turning energy consumption and turning parameters is obtained by using a decision tree algorithm in a data mining technology and then combined with a self-correction module to correct a preliminary prediction result, and energy consumption in the numerically controlled lathe turning process is pre-calculated and used to guide an actual machining process. In addition, a model and a historical turning parameter database can be continuously updated according to actual conditions, so that the prediction precision of the prediction model is continuously improved, and an operator can select more reasonable turning parameters, thus finally helping enterprises to improve the machining efficiency.

### TECHNICAL FIELD

The present disclosure herein relates to a system and a method for predicting energy consumption in a numerically controlled lathe turning process based on a decision tree and belongs to the technical field of lathe control systems.

### BACKGROUND

At present, there is no relatively unified technical system for the prediction of energy consumption in a numerically controlled lathe turning process. Traditional methods are mainly characterized in that an experienced operator comprehensively selects appropriate turning parameters according to experience and an operation manual, or reasonably selects the turning parameters through on-site cutting experiments or monitoring of a machining process. Such methods are greatly different due to different influences of subjective factors of workers, specific lathe types, machining methods and machining objects, and cannot be popularized on a large scale. Various hypotheses and theoretical models have been proposed by scholars, and various mathematical methods have been applied to the prediction of energy consumption in the numerically controlled lathe turning process, such as a support vector machine method and a neural network method.

The support vector machine method involves the calculation of an m-order matrix (m is the number of samples) when a support vector is solved through quadratic programming, and when m is large, the storage and calculation of the m-order matrix consume a large amount of machine memory and operation time; in addition, a typical support vector machine method only gives a binary classification algorithm, which needs to be combined with other algorithms to solve the multi-class classification problems in the practical application of data mining, and the solving process and the involved algorithms are more complex.

While, the above-mentioned neural network method has the defects that the training time of sample data is long or even the sample data cannot be trained at all. In addition, the sample training process also has the problem that old samples are forgotten when new samples are learned.

### SUMMARY

In order to solve the above-mentioned problems, based on a large amount of historical data generated in a turning process, the present disclosure provides a system and a method for predicting energy consumption in a numerically controlled lathe turning process based on a decision tree, which fully weigh the influence of various factors on the energy consumption in the numerically controlled lathe turning process by utilizing a decision tree algorithm in a data mining technology, establish a quantitative relationship between each turning parameter and the energy consumption in the turning process, and accordingly establish a decision tree prediction model for energy consumption to perform energy consumption prediction for the numerically controlled lathe turning process.

A first object of the present disclosure is to provide a system for predicting energy consumption in a numerically controlled lathe turning process based on a decision tree, and the system includes:

a data preparation module, an energy consumption prediction module and a self-correction module.

The data preparation module is configured to select parameters to establish a sample set, and preprocess parameter attribute values in the sample set, the selected parameters at least include a spindle speed, a back engagement, a feed rate and a cutting speed; the energy consumption prediction module is configured to establish a decision tree prediction model and perform preliminary energy consumption prediction on the numerically controlled lathe turning process; and the self-correction module is configured to correct the decision tree prediction model for turning process energy consumption, and the energy consumption prediction module and the self-correction module work cooperatively to perform energy consumption prediction for the numerically controlled lathe turning process; and

in the process of performing energy consumption prediction for the numerically controlled lathe turning process, the system continuously selects samples with typical characteristics are continuously to add into a training sample set, and does not add sample data the same as that existing in a database, and the samples with typical characteristics are samples having a similarity larger than a set threshold value with the data samples existing in the database.

Optionally, the threshold value is ξ, and a data set of r samples E=(e₁,e₂ . . . eᵣ) is set, where a central sample is e_{ƒ}(ƒ∈1,2 . . . ,r); eₚ is set as a data sample to be detected, where p ∉(1,2, . . . , r); and e_{q} is a known data sample in the data set Ε, where q ∈(1,2, . . . , r).

Continuously selecting the samples with typical characteristics to add into the training sample set includes:

measuring a similarity between the samples by a distance l(eₚ,e_{q}) between the samples:

$$l ( {e}_{p} , {e}_{q} ) = \sqrt{{\sum }_{τ = 1}^{r} {[ {e}_{p} ( τ ) - {e}_{q} ( τ ) ]}^{2}} , \\ p ∉ ( 1 , 2 , … , r ) , q ∈ ( 1 , 2 , … , r ) ;$$

and

if l(eₚ,e_{q})/l(eₚ,e_{ƒ})>ξ, adding eₚ into the data set Ε to be stored as new sample data and retraining the decision tree prediction model for energy consumption; otherwise considering that same sample data exists in the sample data set Ε, i.e., eₚ does not need to be added into the sample data set E, where the central sample

$${e}_{f} = \frac{1}{r} {\sum }_{q = 1}^{r} {e}_{q} .$$

Optionally, the data preparation module includes:

a historical turning energy consumption data reading unit and a real-time turning parameter data acquisition unit;

the historical turning energy consumption data reading unit is configured to read historical turning energy consumption data; and

the turning parameter data acquisition unit is configured to acquire turning parameter data.

Optionally, the self-correction module includes:

an energy consumption detection unit, configured to actually detect the energy consumption in the turning process.

A second object of the present disclosure is to provide a method for predicting energy consumption in a numerically controlled lathe turning process based on a decision tree, and the method includes:

selecting parameters to establish a sample set;

calling a decision tree algorithm to establish a decision tree prediction model; and

correcting the decision tree prediction model so as to accurately predict the energy consumption in the numerically controlled lathe turning process.

Optionally, selecting the parameters to establish the sample set includes:

obtaining basic data of known samples from a turning parameter database to form the sample set according to a relationship between historical turning parameters and turning energy consumption; and dividing the sample set into two types of samples, where one type is used as a training sample set for establishing the decision tree prediction model for energy consumption, and the other type is used as a test sample set for correcting incorrect data in the preliminarily established decision tree prediction model for energy consumption.

Optionally, before calling the decision tree algorithm to establish the decision tree prediction model, the method further includes:

preprocessing parameter attribute values in the sample set; and

discretizing the preprocessed continuous parameter attributes and converting into a data format required for calling the decision tree algorithm.

Optionally, discretizing the preprocessed continuous parameter attributes includes:

forming an attribute set A={A₁, A₂, . . . , Aₙ} with continuous values of various turning parameters in the training sample set S, which indicates that n attributes exist in the attribute set A, and each parameter attribute Aⱼ has t different values, namely Aⱼ={a₁,a₂, . . . , aₜ}, and j=1,2 . . . n;

dividing the training sample set S into t subsets S={S₁,S₂, . . . ,Sₜ};

sequentially arranging the t different values in the attribute Aₗ in an ascending order, where a sequence of the arranged attribute values is B₁, B₂, . . . ,Bₜ, obtaining an average value

$$C = \frac{{B}_{i} + {B}_{i + 1}}{2}$$

of every two adjacent values one by one to serve as a split point, where i ∈(1,2, . . . , t), and dividing the attribute values into two subsets corresponding to Aⱼ≤C and Aⱼ>C through t−1 split points, where j=1,2 . . . n;

calculating an information gain rate of each split point;

taking a split point c′ corresponding to a maximum information gain rate GR(c′) as a local threshold value; and

taking a value C which does not exceed but is closest to the local threshold value c′ from B₁, B₂, . . . ,Bₜ as a split threshold value of the parameter attribute Aⱼ.

Optionally, calling the decision tree algorithm to establish the decision tree prediction model includes:

respectively calculating an information gain rate of each parameter attribute in the training sample set, selecting the attribute with a maximum information gain rate as a test attribute, and establishing a root node of the decision tree;

after dividing the training sample set into the t subsets, sequentially dividing the subsets in a new round by adopting the same method until the subsets cannot be divided or a termination condition is reached, and establishing a preliminary decision tree prediction model; and

substituting real-time detected turning parameter data into the decision tree prediction model to generate a preliminary prediction result by combining historical data, and storing the result into a turning parameter basic database to form historical data.

Optionally, calculating the information gain rate of each parameter attribute in the training sample set includes:

on the basis that the training sample set S={S₁,S₂, . . . ,Sₘ} and includes m classes Cₖ,k=1,2, . . . , m, and Sₖ is the number of samples in the classes C′ₖ, recording the amount of information required for classification as l(S), then

$$I ( S ) = I ( {S}_{1} , {S}_{2} , … , {S}_{m} ) = - {\sum }_{k = 1}^{m} {p}_{k} {log}_{2} {p}_{k} , k = 1 , 2 … m ,$$

where pₖ is the probability that any sample in the training sample set S belongs to the classes Cₖ;

dividing the training sample set S into the t subsets according to t different values of the attribute set Aⱼ={a₁,a₂, . . . , aₜ} (j=1,2 . . .n), recorded as S={S₁, S₂. . . , Sₜ},

where Sₕ, h=1,2 . . . t is a subset of S and has a value aⱼ on the attribute Aⱼ, and aⱼ is a j^{th} component of the attribute Aⱼ, and then expressing an information entropy E(Aⱼ) of the subsets divided by the attribute Aⱼ as:

$$E ( {A}_{j} ) = {\sum }_{h = 1}^{t} \frac{\vert {S}_{h} \vert}{\vert S \vert} I ( {S}_{h} ) , j = 1 , 2 , … , n , h = 1 , 2 … t ;$$

then expressing an information gain G(Aⱼ) of the subsets divided by the attribute Aⱼ as:

G(Aⱼ)=I(S)−E(Aⱼ), j=1,2 . . . n; and

according to the fact that the information gain rate is equal to a ratio of the information gain to split information amount, through a split information amount calculation formula:

$$Split ( {A}_{j} ) = - {\sum }_{h = 1}^{t} \frac{\vert {S}_{h} \vert}{\vert S \vert} {log}_{2} ( \frac{\vert {S}_{h} \vert}{\vert S \vert} ) , j = 1 , 2 … n , h = 1 , 2 … t ,$$

expressing a final information gain rate GR(A_{J}) of the subsets divided by the attribute A as:

$$GR ( {A}_{j} ) = \frac{G ( {A}_{j} )}{Split ( {A}_{j} )} , j = 1 , 2 … n .$$

Optionally, correcting the decision tree prediction model so as to accurately predict the energy consumption in the numerically controlled lathe turning process includes:

correcting incorrect data in the generated preliminary prediction result by using the test sample set; and

updating the training sample set to improve the accuracy of the decision tree prediction model for energy consumption.

Optionally, updating the training sample set includes:

selecting the samples with typical characteristics to add into the training sample set, and not adding sample data the same as that existing in the database, specifically,

setting a data set of r samples E=(e,₁,e₂. . . eᵣ), where a central sample is e_{ƒ}(ƒ∈1,2, . . . ,r); setting eₚ as a data sample to be detected, p ∉(1,2, . . . r), where e_{q} is a known data sample in the data set Ε, and q ∈(1,2, . . . ,r);

measuring a similarity between the samples by a distance l(eₚ,e_{q}) between the samples:

$$l ( {e}_{p} , {e}_{q} ) = \sqrt{{\sum }_{τ = 1}^{r} {[ {e}_{p} ( τ ) - {e}_{q} ( τ ) ]}^{2}} , \\ p ∉ ( 1 , 2 , … , r ) , q ∈ ( 1 , 2 , … , r ) ;$$

and

setting a threshold value ξ, if l(eₚ,e_{q})/l(eₚ,e_{ƒ})>ξ, adding eₚ into the data set Ε to be stored as new sample data and retraining the decision tree prediction model for energy consumption; otherwise considering that same sample data exists in the sample data set Ε, i.e., eₚ does not need to be added into the sample data set Ε, where the central sample

$${e}_{f} = \frac{1}{r} {\sum }_{q = 1}^{r} {e}_{q} .$$

Optionally, the method further includes:

actually detecting the energy consumption in the turning process;

comparing a preliminary prediction result predicted by an energy consumption prediction module with actually detected energy consumption to obtain an error e;

judging whether the error e is within an error allowable range or not, and if the judgment result is yes, judging the prediction result to be acceptable;

if the judgment result is no, feeding the result back to the energy consumption prediction module through a self-correction module, re-predicting and recalculating a new round of error through the energy consumption prediction module by combining the obtained error e, and repeating the process until the obtained error is within the error allowable range, where the error allowable range is preset according to actual situtations; and

correcting the preliminary prediction result through the self-correction module, and combining the obtained correction amount with the preliminary prediction result to obtain a final prediction result.

Optionally, the parameters in the sample set established by selecting the parameters include a spindle speed, a back engagement, a feed rate and a cutting speed.

A third object of the present disclosure is to provide a lathe including the system for predicting energy consumption in a numerically controlled lathe turning process based on a decision tree.

The present disclosure has the following beneficial effects.

Based on a large amount of historical data generated in the turning process, the energy consumption in the numerically controlled lathe turning process is predicted, and the limit of the traditional energy consumption prediction algorithm on workshop specific environmental factors such as lathe models and workpiece machining methods is broken through; meanwhile, the influence of various factors on the turning energy consumption of the numerically controlled lathe is fully considered, the quantitative relationship between the turning energy consumption and the turning parameters is obtained by utilizing the decision tree algorithm in the data mining technology, and then the quantitative relationship is combined with the self-correction module to correct the preliminary prediction result, so that the energy consumption in the numerically controlled lathe turning process is calculated in advance, and used to guide the actual machining process. In addition, the model and the historical turning parameter database can be continuously updated according to actual situations, so that the prediction accuracy of the prediction model is continuously improved, and an operator can select more reasonable turning parameters, thus finally helping enterprises to improve the machining efficiency.

### BRIEF DESCRIPTION OF FIGURES

In order to more clearly illustrate the technical solutions of the embodiments of the present disclosure, the drawings used in the description of the embodiments are briefly described below, and it is obvious that the drawings in the description below are only some embodiments of the present disclosure, and a person of ordinary skill in the art can obtain other drawings from these drawings without any creative effort.

FIG. 1 is a structural diagram of a system for predicting energy consumption in a numerically controlled lathe turning process based on a decision tree according to the present disclosure; and

FIG. 2 is a flow diagram of prediction of energy consumption in a numerically controlled lathe turning process based on a decision tree according to the present disclosure.

FIG. 3 is a hierarchical schematic diagram of non-dominated solutions.

FIG. 4 is a flow diagram of an improved algorithm according to the present disclosure.

FIG. 5 is an AHP multi-level hierarchical structural diagram.

FIG. 6 is a simulation diagram of a Pareto front solution result.

FIG. 7 is a diagram showing energy consumption comparison between the method according to the present disclosure and another two methods.

### DETAILED DESCRIPTION

In order that objects, technical solutions, and advantages of the present disclosure will become more apparent, implementations of the present disclosure will be described in further detail with reference to the accompanying drawings.

### Embodiment 1

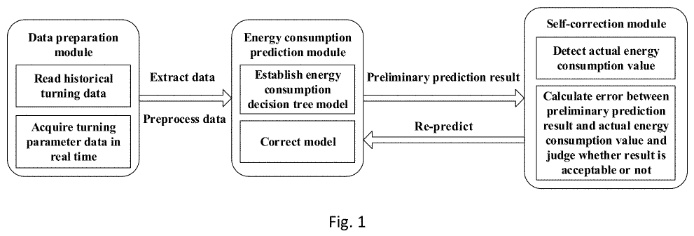

The present embodiment provides a system for predicting energy consumption in a numerically controlled lathe turning process based on a decision tree, and as shown in FIG. 1, the system includes:

a data preparation module, an energy consumption prediction module and a self-correction module.

The data preparation module is configured to select parameters to establish a sample set, and preprocess parameter attribute values in the sample set; the energy consumption prediction module is configured to establish a decision tree prediction model and perform preliminary energy consumption prediction on the numerically controlled lathe turning process; and the self-correction module is configured to correct the decision tree prediction model for turning process energy consumption, and the energy consumption prediction module and the self-correction module work cooperatively to perform energy consumption prediction for the numerically controlled lathe turning process.

A quantitative relationship between the turning energy consumption and the turning parameters is obtained by utilizing a decision tree algorithm in a data mining technology, and then the quantitative relationship is combined with the self-correction module to correct a preliminary prediction result, so that the energy consumption in the numerically controlled lathe turning process is calculated in advance, and used to guide the actual machining process, the training time of sample data is shortened, and the prediction accuracy of the prediction model is improved.

### Embodiment 2

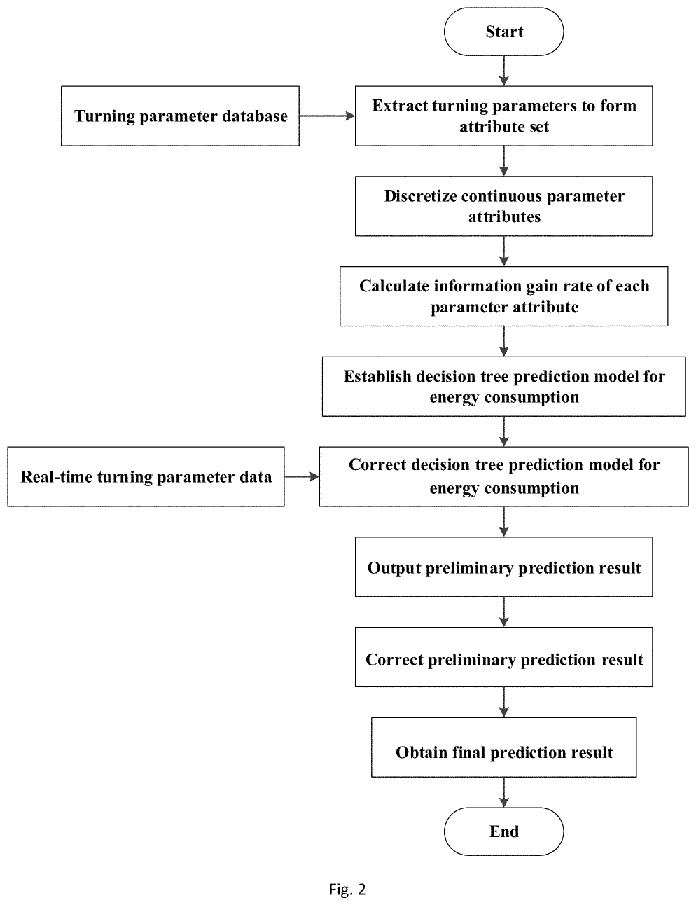

The present embodiment provides a method for predicting energy consumption in a numerically controlled lathe turning process based on a decision tree, and as shown in FIG. 2, the method is applied in a system for predicting energy consumption in a numerically controlled lathe turning process based on a decision tree, where the system for predicting energy consumption in a numerically controlled lathe turning process based on a decision tree includes:

a data preparation module, an energy consumption prediction module and a self-correction module.

The data preparation module mainly includes a historical turning energy consumption data reading unit and a real-time turning parameter data acquisition unit, and is mainly used to preprocess various data, convert the data into a data format required by a data mining decision tree algorithm, and then transmit the data to the energy consumption prediction module; after the work of the data preparation module is finished, the real-time turning parameter data acquisition module and the energy consumption prediction module are combined, the decision tree algorithm is called, then a model is corrected, and a preliminary energy consumption prediction result is output; the self-correction module includes an energy consumption detection unit, the energy consumption detection unit is configured to actually detect the energy consumption in the turning process, the preliminary prediction result predicted by the energy consumption prediction module is compared with the energy consumption actually detected by an energy consumption detection device, and a final prediction result can be obtained by correcting according to the comparison result.

The prediction method applied in the system for predicting energy consumption in a numerically controlled lathe turning process based on a decision tree includes the following steps.

Step 1: two tasks of reading historical turning energy consumption data and acquiring real-time turning parameter data are completed by the data preparation module, the obtained data is preprocessed, converted into the data format required by the data mining decision tree algorithm and transmitted to the energy consumption prediction module.

Step 2: after the tasks of the data preparation module in step 1 are completed, the real-time turning parameter data acquisition module and the energy consumption prediction module are enabled to work cooperatively to call the decision tree algorithm, and establish a decision tree prediction model for turning process energy consumption.

Step 3: the decision tree prediction model for energy consumption obtained in step 2 is corrected to obtain a preliminary prediction result.

Step 4: the preliminary prediction result obtained in step 3 is transmitted to the self-correction module, the self-correction module and the energy consumption prediction module are enabled to work cooperatively to correct the preliminary prediction result to obtain a final prediction result.

As shown in FIG. 2, predicting the energy consumption in the numerically controlled lathe turning process includes the following steps.

Step 1.1: main parameter attributes such as a spindle speed, a back engagement, a feed rate and a cutting speed are selected by the data preparation module from a turning parameter database to form an attribute set as an evaluation index.

Step 1.2: each parameter attribute value extracted from the turning parameter database and each parameter attribute value detected in real time are preprocessed, and continuous attributes are discretized, converted into a data format required for calling the decision tree algorithm, and transmitted the energy consumption prediction module.

Step 1.3: an information gain rate of each parameter attribute is calculated, the attribute with a maximum information gain rate is selected as a root node of the decision tree, branches are established according to different values of the attribute, branches of each node of the decision tree are established by calling the method until all subsets contain only data of the same category, and the decision tree prediction model for turning process energy consumption is established.

Step 1.4: the decision tree prediction model for energy consumption established in step 1.3 is corrected to improve the prediction accuracy of the model and output the preliminary energy consumption prediction result.

Step 1.5: the preliminary prediction result is transmitted to the self-correction module, and the self-correction module and the energy consumption prediction module are enabled to work cooperatively to correct the preliminary prediction result to obtain the final prediction result.

The implementation process and principles of the present disclosure are further illustrated by combining with the following embodiments.

1. Extraction of turning parameter basic data.

As shown in FIG. 2, in the process of predicting the energy consumption in the numerically controlled lathe turning process, the first step is the data preparation stage. That is, a large amount of basic data of known samples is obtained from the turning parameter database according to the relationship between historical turning parameters and turning energy consumption to form a sample set, and then the sample set is divided into two types of samples, one type is used as a training sample set for establishing the decision tree prediction model for energy consumption, and the other type is used as a test sample set for correcting incorrect data in the preliminarily established decision tree prediction model for energy consumption. Because original data contain a large amount of incomplete and noisy data, the original data must be preprocessed to improve the quality of the data and improve the accuracy of the prediction result.

2. Discretization of continuous attribute values in training sample set and calculation of information gain rate.

Continuous values of various turning parameters in the training sample set S form an attribute set A={A₁, A₂, . . . , Aₙ}, which indicates that n attributes exist in the attribute set A, and each parameter attribute Aⱼ has t different values, namely Aⱼ={a₁, a₂, . . . , aₜ} and j=1,2 . . . n;

the training sample set S is divided into t subsets S={S₁,S₂, . . .,Sₜ};

the continuous attribute values in the attribute Aⱼ are subjected to discretization, specifically,

the t different values in the attribute Aⱼ are sequentially arranged in an ascending order, a sequence of the arranged attribute values is B₁, B₂, . . . ,Bₜ, and an average value

$$C = \frac{{B}_{i} + {B}_{i + 1}}{2}$$

of every two adjacent values is obtained one by one to serve as a split point, where i ∈(1,2, . . . , t); and

the attribute values are divided into two subsets corresponding to Aⱼ≤C and through t−1 split points, where j=1,2 . . . n;

an information gain rate of each split point is calculated;

a split point c′ corresponding to a maximum information gain rate GR(c′) is taken as a local threshold value, so an information gain rate of the sample sets divided by the continuous attribute Aⱼ is GR(c′); and

a value C which does not exceed but is closest to the local threshold value c′ is taken from B₁, B₂, . . . ,Bₜ as a split threshold value of the attribute Aⱼ.

3, Establishment of decision tree prediction model for energy consumption.

The training sample set S={S₁,S₂, . . . ,Sₙ} and includes m classes Cₖ,k=1,2, . . . , m, Sᵢ, is the number of samples in the classes Cₖ, and the amount of information required for classification is recorded as I(S), so

$$I ( S ) = I ( {S}_{1} , {S}_{2} , … , {S}_{m} ) = - {\sum }_{k = 1}^{m} {p}_{k} {log}_{2} {p}_{k} , k = 1 , 2 … m ,$$

where pₖ is the probability that any sample in the training sample set S belongs to the classes Cₖ;

the training sample set S is divided into the t subsets according to t different values of the attribute set Aⱼ={α₁, α₂, . . .,αₜ}(j=1,2 . . . n), recorded as S={S₁,S₂, . . . ,Sₜ},

where Sₕ, h=1,2 . . .t is a subset of S and has a value 60 ⱼ on the attribute Aⱼ, αⱼ is a j^{th}component of the attribute Aⱼ, and then an information entropy E(Aⱼ) of the subsets divided by the attribute Aⱼ can be expressed as:

$$E ( {A}_{j} ) = {\sum }_{h = 1}^{t} \frac{\vert {S}_{h} \vert}{\vert S \vert} I ( {S}_{h} ) , j = 1 , 2 , … , n , h = 1 , 2 … t ;$$

then the information gain G(Aⱼ) of the subsets divided by the attribute Aⱼ can be expressed as:

G(Aⱼ)=I(S)−E(Aⱼ), j=1,2 . . . n; and

the information gain rate is equal to a ratio of the information gain to split information amount, and through a split information amount calculation formula:

$$Split ( {A}_{j} ) = - {\sum }_{h = 1}^{t} \frac{\vert {S}_{h} \vert}{\vert S \vert} {log}_{2} ( \frac{\vert {S}_{h} \vert}{\vert S \vert} ) , j = 1 , 2 … n , h = 1 , 2 … t ,$$

a final information gain rate GR(A_{J}) of the subsets divided by the attribute Aⱼ is expressed as:

$$GR ( {A}_{j} ) = \frac{G ( {A}_{j} )}{Split ( {A}_{j} )} , j = 1 , 2 … n .$$

Therefore, the information gain rate of each parameter attribute in the training sample set S is calculated respectively, the attribute with a maximum information gain rate is selected as a test attribute, and the root node of the decision tree is established. A new round of division is carried out on the subsets in sequence by adopting the same method until the subsets cannot be divided or a termination condition is reached, and the preliminary decision tree prediction model for energy consumption is established. Meanwhile, real-time detected turning parameter data is substituted into the decision tree model, the preliminary prediction result is generated by combining historical data, and the result is stored in the turning parameter database to form historical data.

4. Correction of generated decision tree prediction model for energy consumption.

On the one hand, incorrect data in the generated energy consumption decision tree are corrected by using the test sample set, and on the other hand, because the turning parameters in actual operation of the numerically controlled lathe may change, the samples need to be updated regularly to improve the accuracy of the decision tree prediction model for energy consumption. Because the sample data is very large, samples with typical characteristics can be selected and added into the training sample set, and sample data the same as that existing in the database do not need to be added, and the specific operation method includes the following steps.

The data set of r samples E=(e₁, e₂. . . eᵣ), is set, where a central sample is e₇₁ (ƒ∈1,2, . . . ,r); eₚ is set as a data sample to be detected, p ∉(1,2, . . . ,r), e_{q} is a known data sample in the data set E, and q ∈(1,2, . . . ,r).

A similarity between the samples is measured by a distance l(eₚ, e_{q}) between the samples:

$$l ( {e}_{p} , {e}_{q} ) = \sqrt{{\sum }_{τ = 1}^{r} {[ {e}_{p} ( τ ) - {e}_{q} ( τ ) ]}^{2}} , \\ p ∉ ( 1 , 2 , … , r ) , q ∈ ( 1 , 2 , … , r ) ;$$

a threshold value ξ is set, if l(eₚ,e_{q})/l(eₚ,e_{ƒ})>ξ, eₚ is added into the data set Ε to be stored as new sample data and the decision tree prediction model for energy consumption is retrained; otherwise it is considered that same sample data exist in the sample data set Ε, i.e., eₚ does not need to be added into the sample data set Ε, where the central sample

$${e}_{f} = \frac{1}{r} {\sum }_{q = 1}^{r} {e}_{q} .$$

Meanwhile, the decision tree prediction model for energy consumption may be combined with a corresponding expert system, the decision tree prediction model for energy consumption can be further improved by utilizing professional expert knowledge, and the prediction accuracy of the model can be further improved.

5. Correction of preliminary energy consumption prediction result by self-correction module.

The self-correction module is internally provided with an actual energy consumption detection device, and an established energy consumption correction model has learning and memory functions. The preliminary prediction result predicted by the energy consumption prediction module is compared with the energy consumption actually detected by the energy consumption detection device to obtain an error e, a reasonable error allowable range is set as a judgment standard of a result in advance according to the requirement of an actual problem, and when the error e meets the set judgment standard, the prediction result is judged to be acceptable; when the error e does not meet the judgment standard, the self-correction module feeds the result back to the energy consumption prediction module, the energy consumption prediction module re-predicts and recalculates a new round of error by combining the obtained error e, and the process is repeated until the obtained error meets the judgment standard set according to actual situations. In this way, the preliminary prediction result obtained each time is continuously corrected through feedback, and is closer to the real value of energy consumption, so that the prediction accuracy is improved. Thus, the preliminary prediction result is corrected through the self-correction module, and the obtained correction amount is combined with the preliminary prediction result, so that the final prediction result is obtained.

The results of the system and method for predicting energy consumption a numerically controlled lathe turning process based on a decision tree provided by the present disclosure are compared with the results of three other models for predicting energy consumption in a numerically controlled lathe turning process by referring to the following comparison example:

Comparative example

According to the comparison example 1, a total of 96 groups of cutting parameter data including a spindle speed, a back engagement, a feed rate, an initial value diameter, a cutting speed and a main cutting force are selected, a cutting power (a prediction result) under each group of cutting parameter data is known, and the data is from Research on Cutting Energy Consumption Prediction Methods for Workpiece Machining Process and Development of Application System of Master' Thesis of Qiu Hang (2016, Chongqing University).

Two sets of prediction sets are set as a prediction set 1 and a prediction set 2 respectively, each prediction set randomly selects 10 sets (accounting for 10% of the total data) of the data in table 1, and the remaining data is used as a training set, and programming is carried out on a Matlab R2014a platform to realize the energy consumption prediction for a numerically controlled lathe turning process, and a prediction result is compared with cutting power values obtained by a traditional cutting power index prediction model, a specific cutting rate prediction model and a comprehensive prediction model of the above two models, so that the beneficial effects achieved by the present disclosure are further explained. The error comparison between the predicted power obtained by the four models in the prediction set 1 and the prediction set 2 and the actual power is shown in Tables 1-2.

TABLE 1
Error Comparison Between Predicted Power of Four Models in Prediction Set 1 and Actual Power

| | | | | | | | | Specific | Comprehensive | Decision |
|---|---|---|---|---|---|---|---|---|---|---|
| | | | Initial | | Main | Actual | Index | cutting | prediction | tree model |
| Spindle | Back | Feed | value | Cutting | cutting | cutting | model | force model | model | (present |
| speed | engagement | rate | diameter | speed | rate | power | (traditional) | (traditional) | (traditional) | disclosure) |
| 350 | 0.5 | 0.157 | 54.1 | 59.49 | 169.2 | 167.75 | 3.03% | 19.41% | 7.08% | 13.24% |
| 350 | 0.75 | 0.157 | 53.1 | 58.39 | 260 | 253.01 | 0.86% | 16.56% | 9.36% | 6.06% |
| 560 | 1 | 0.035 | 58.6 | 103.09 | 79.51 | 136.62 | 30.99% | 64.86% | 1.26% | 76.58% |
| 560 | 0.75 | 0.121 | 54.6 | 96.06 | 144.8 | 231.82 | 38.24% | 72.15% | 4.62% | 1.01% |
| 560 | 1 | 0.241 | 46.6 | 81.98 | 167.6 | 229.01 | 173.39% | 232.45% | 97.04% | 1.59% |
| 560 | 1 | 0.286 | 58.6 | 103.1 | 208.2 | 357.74 | 141.79% | 204.32% | 86.93% | 32.57% |
| 700 | 0.75 | 0.198 | 38.1 | 83.79 | 284.8 | 397.71 | 3.79% | 26.63% | 23.13% | 0.76% |
| 700 | 0.75 | 0.286 | 34.6 | 76.09 | 306.1 | 388.18 | 29.09% | 55.24% | 8.17% | 1.67% |
| 870 | 0.5 | 0.06 | 49.6 | 135.57 | 129.1 | 291.69 | 42% | 23.94% | 44.84% | 25.79% |
| 870 | 0.5 | 0.157 | 45.1 | 123.27 | 163 | 334.87 | 4.12% | 23.94% | 11.96% | 2.88% |

| | | | | |
|---|---|---|---|---|
| average error | 46.73% | 73.95% | 29.44% | 16.22% |

TABLE 2
Error Comparison Between Predicted Power of Four Models in Prediction Set 2 and Actual Power

| | | | | | | | | Specific | Comprehensive | Decision |
|---|---|---|---|---|---|---|---|---|---|---|
| | | a | Initial | | Main | Actual | Index | cutting | prediction | tree model |
| Spindle | Back | feed | value | Cutting | cutting | cutting | model | force model | model | (present |
| speed | engagement | rate | diameter | speed | rate | power | (traditional) | (traditional) | (traditional) | disclosure) |
| 350 | 0.75 | 0.06 | 57.6 | 63.33 | 173 | 182.61 | 27.22% | 14.86% | 33.61% | 36.13% |
| 350 | 1 | 0.121 | 56.1 | 61.68 | 280.2 | 288.07 | 1.78% | 18.6% | 7.59% | 12.17% |
| 350 | 1 | 0.157 | 51.6 | 56.74 | 319 | 301.65 | 10.08% | 208.07% | 172.81% | 34.38% |
| 560 | 0.5 | 0.035 | 56.6 | 99.57 | 89.3 | 148.2 | 41.38% | 26.61% | 55.16% | 35.63% |
| 560 | 0.75 | 0.092 | 57.6 | 101.33 | 133.3 | 225.13 | 21.29% | 52.25% | 6.72% | 1.49% |
| 560 | 0.5 | 0.198 | 47.6 | 83.74 | 150.7 | 210.33 | 30.78% | 59.54% | 5.12% | 6.5% |
| 700 | 0.5 | 0.06 | 51.6 | 113.47 | 116.5 | 220.33 | 33.99% | 15.71% | 44.86% | 32.39% |
| 700 | 0.75 | 0.121 | 42.6 | 93.68 | 174 | 271.68 | 15.47% | 43.25% | 10.51% | 21.77% |
| 870 | 1 | 0.092 | 42.6 | 116.43 | 283.2 | 549.57 | 25.45% | 4.44% | 32.98% | 8.97% |
| 870 | 0.75 | 0.121 | 44.1 | 120.53 | 193.8 | 398.32 | 2.43% | 25.72% | 11.14% | 3.39% |

| | | | | |
|---|---|---|---|---|
| average error | 20.99% | 46.91% | 38.05% | 19.28% |

From the data in Tables 1-2, in the prediction set 1, the prediction accuracy of the decision tree prediction model is 65.29%, 78.07% and 44.9% higher than those of the cutting power index model, the specific cutting rate model and the comprehensive prediction model of the two; and in the prediction set 2, the prediction accuracy of the decision tree prediction model is 8.15%, 58.9% and 49.33% higher than those of the cutting power index model, the specific cutting rate model and the comprehensive prediction model of the two. The prediction of cutting power by the traditional cutting power index model and the specific cutting force model depends too much on the specific lathe types, workpiece materials, machining methods and other workshop environmental conditions, and a deviation between predicted power and actual power is large; however, the comprehensive prediction model of the two models obtains a compromise prediction result by integrating the prediction results of the two, so that the overall prediction result is between the prediction results of the two or better than the prediction results of the two, but the overall prediction result is essentially still limited by factors such as specific lathe types, workpiece materials, machining methods and other workshop environmental conditions.

In general, the prediction results of the decision tree prediction model are more accurate than those of the other three traditional prediction models, but there is still a large deviation between a few predicted values and actual values due to the small amount of data of such samples in the training set. Therefore, the decision tree model needs to be corrected (primary correction), the correction process is not described in detail, the preliminary prediction result is obtained, and then the preliminary prediction result is compared with the actually detected energy consumption to obtain the error e (e=10% in the comparison example 1): when the error e meets the set judgment standard, the prediction result is judged to be acceptable; when the error e does not meet the judgment standard, the self-correction module feeds the result back to an energy consumption prediction module, the energy consumption prediction module re-predicts and recalculates a new round of error by combining the obtained error e, and the process is repeated until the obtained error meets the judgment standard set according to actual situations (secondary correction). In this way, the preliminary prediction result obtained each time is continuously corrected through feedback, and is closer to the real value of energy consumption, so that the prediction accuracy is improved. The error comparison between the predicted power obtained after two times of correction and the actual power is shown in Tables 3-4.

TABLE 3
Error Comparison Between Predicted Power after Two Times of Decision
Tree Model Correction in Prediction Set 1 and Actual Power

| | | | Initial | | Main | Actual | | | |
|---|---|---|---|---|---|---|---|---|---|
| Spindle | Back | Feed | value | Cutting | cutting | cutting | Decision | Primary | Secondary |
| speed | engagement | rate | diameter | speed | rate | power | tree model | correction | correction |
| 350 | 0.5 | 0.157 | 54.1 | 59.49 | 169.2 | 167.75 | 13.24% | 4.23% | 4.23% |
| 350 | 0.75 | 0.157 | 53.1 | 58.39 | 260 | 253.01 | 6.06% | 8.42% | 0% |
| 560 | 1 | 0.035 | 58.6 | 103.09 | 79.51 | 136.62 | 76.58% | 0% | 0% |
| 560 | 0.75 | 0.121 | 54.6 | 96.06 | 144.8 | 231.82 | 1.01% | 2.89% | 2.89% |
| 560 | 1 | 0.241 | 46.6 | 81.98 | 167.6 | 229.01 | 1.59% | 0.92% | 1.28% |
| 560 | 1 | 0.286 | 58.6 | 103.1 | 208.2 | 357.74 | 32.57% | 37.98% | 0% |
| 700 | 0.75 | 0.198 | 38.1 | 83.79 | 284.8 | 397.71 | 0.76% | 2.4% | 2.4% |
| 700 | 0.75 | 0.286 | 34.6 | 76.09 | 306.1 | 388.18 | 1.67% | 0% | 0% |
| 870 | 0.5 | 0.06 | 49.6 | 135.57 | 129.1 | 291.69 | 25.79% | 25.79% | 0% |
| 870 | 0.5 | 0.157 | 45.1 | 123.27 | 163 | 334.87 | 2.88% | 2.88% | 2.88% |

| | | | |
|---|---|---|---|
| average error | 16.22% | 8.55% | 1.37% |

TABLE 4
Error Comparison Between Predicted Power after Two Times of Decision
Tree Model Correction in Prediction Set 2 and Actual Power

| | | | Initial | | Main | Actual | | | |
|---|---|---|---|---|---|---|---|---|---|
| Spindle | Back | Feed | value | Cutting | cutting | cutting | Decision | Primary | Secondary |
| speed | engagement | rate | diameter | speed | rate | power | tree model | correction | correction |
| 350 | 0.75 | 0.06 | 57.6 | 63.33 | 173 | 182.61 | 36.13% | 36.13% | 0% |
| 350 | 1 | 0.121 | 56.1 | 61.68 | 280.2 | 288.07 | 12.17% | 0% | 0% |
| 350 | 1 | 0.157 | 51.6 | 56.74 | 319 | 301.65 | 34.38% | 9.06% | 9.06% |
| 560 | 0.5 | 0.035 | 56.6 | 99.57 | 89.3 | 148.2 | 35.63% | 0% | 0% |
| 560 | 0.75 | 0.092 | 57.6 | 101.33 | 133.3 | 225.13 | 1.49% | 2.13% | 2.28% |
| 560 | 0.5 | 0.198 | 47.6 | 83.74 | 150.7 | 210.33 | 6.5% | 0% | 0% |
| 700 | 0.5 | 0.06 | 51.6 | 113.47 | 116.5 | 220.33 | 32.39% | 0% | 0% |
| 700 | 0.75 | 0.121 | 42.6 | 93.68 | 174 | 271.68 | 21.77% | 16.48% | 0% |
| 870 | 1 | 0.092 | 42.6 | 116.43 | 283.2 | 549.57 | 8.97% | 11.21% | 0% |
| 870 | 0.75 | 0.121 | 44.1 | 120.53 | 193.8 | 398.32 | 3.39% | 43.04% | 0% |

| | | | |
|---|---|---|---|
| average error | 19.28% | 11.81% | 1.13% |

From the data in Tables 3-4, in the prediction set 1 and the prediction set 2, most prediction result errors are controlled within 10% after the primary correction and are acceptable, the error level of a few prediction results still exceeds 10%, and this part of prediction results are not acceptable; after the secondary correction, the prediction results of the prediction set 1 and the prediction set 2 are all controlled within 10%, and the prediction results are acceptable. Theoretically, when the sample data is sufficient, the prediction results will tend to be more and more accurate.

From the analysis of Comparative Example 1, it can be seen that the traditional energy consumption prediction model is influenced by the specific workshop environmental factors such as the lathe types, the workpiece types and the workpiece machining methods, and there is a large deviation between the prediction result and the actual energy consumption value. Compared with the traditional energy consumption prediction methods, the decision tree prediction method in the present disclosure has obvious advantages, specifically, 1) the prediction principle is simple, the influence of the specific workshop environment is avoided, and the energy consumption value of the current turning process can be predicted with only a certain amount of relevant parameter data of the turning process and historical energy consumption data; 2) the prediction accuracy is higher than that of the traditional turning process energy consumption prediction model, and when the accumulated historical data is more and more sufficient, the prediction accuracy tends to be more and more accurate; and 3) due to the fact that the constraint conditions of real workshop environment factors on the present disclosure are smaller, the present disclosure has a higher practical application value.

In the machining process of the numerically controlled lathe, after cutting energy consumption is accurately predicted according to the method for predicting energy consumption, more reasonable turning parameters are selected according to the relationship between the energy consumption and the turning parameters, so that the machining process of the numerically controlled lathe is effectively guided, thus helping enterprises to improve the machining efficiency.

The specific process of selecting the more reasonable turning parameters according to the relationship between the energy consumption and the turning parameters is as follows.

I. Determining an energy consumption function of the machining process of the numerically controlled lathe.

During machining of the numerically controlled lathe, there are four processes of starting, standby, no load and machining generally, so an energy consumption model is

E=Eₛₜ+E_{S-S}+Eᵢₑ+E_{c} (1)

where E represents total energy consumption, Eₛₜ represents starting energy consumption of the lathe, E_{S-S} represents standby energy consumption of the lathe, Eᵢₑ represents no-load energy consumption of the lathe, E_{c} represents cutting energy consumption in the machining process, and the cutting energy consumption is the energy consumption predicted by the method.

The starting energy consumption of the lathe is generally fixed and is determined by the performance of the lathe itself. After the lathe is started, the standby energy consumption and the no-load energy consumption are also constants. The cutting energy consumption is most energy-consuming, and is also the main energy consumption.

The cutting energy consumption represents energy consumed by cutting workpiece materials:

E_{c}=∫₀^{t}^{_{c}}P_{c}dt (2)

where P_{c} is cutting power, t_{c} is machining time, and in the turning process, P_{c} can be known from Sheng min, “Research on Cutting Parameters Optimization on NC Turning” [D] [Master Dissertations]. Harbin: Harbin Institute of Technology, 2007:

$${P}_{c} = \frac{1}{6 \times {10}^{4}} {C}_{FC} {a}_{sp}^{{x}_{FC}} {f}^{{y}_{FC}} {v}_{C}^{{n}_{FC}} {K}_{FC} {v}_{C} \qquad ( 3 )$$

where v_{c} represents a cutting speed, ƒrepresents a feed rate, αₛₚ represents a cutting depth, C_{FC}, X_{FC}, y_{FC}, and K_{FC} represent coefficients related to part materials and tool materials, and corresponding numerical values can be searched from a cutting handbook.

So, the machining process energy consumption model is

E=Eₛₜ+Eₛ₋ₛ+Eᵢₑ+E_{c}=Eₛₜ+Eᵢₑ∫₀^{t}^{_{c}}P_{c}dt (4)

II. Determining a machining time function.

A machining time objective function is introduced as another optimization object, and the machining time of the lathe generally comprises cutting time, tool changing time and process auxiliary time, so a time model can be expressed as:

$$\begin{matrix}{T}_{p} = {t}_{c} + {t}_{ct} \frac{{t}_{c}}{T} + {t}_{ot} & ( 5 ) \\ {t}_{c} = \frac{{L}_{w} Δ}{n f {a}_{sp}} = \frac{π {d}_{0} {L}_{w} Δ}{1000 {v}_{c} f {a}_{sp}} & ( 6 )\end{matrix}$$

where t_{c} represents cutting time from the beginning of machining to the end of a part, tₒₜ represents auxiliary time such as clamping, L_{w} represents a length of the machined part, T represents service life of a tool used for machining, t_{ct} represents time for changing tool once by a tool magazine, Δ represents an allowance left by the machining, d₀ represents a diameter of the machined part, n represents a spindle rotating speed of the lathe, v_{c} represents the cutting speed of the lathe, αₛₚ represents the cutting depth and ƒ represents the feed rate.

The service life T of the tool is determined according to a Taylor generalized calculation formula:

$$T = \frac{{C}_{T}}{{v}_{c}^{x} {f}^{y} {a}_{sp}^{z}} \qquad ( 7 )$$

where C_{T} represents constant values related to machining conditions such as the part, the tool and the lathe, and x, y, and z represent service life coefficients of the tool.

So, the machining time function is

$${T}_{p} = \frac{π {d}_{0} {L}_{w} Δ}{1000 {v}_{c} {fa}_{sp}} + \frac{{t}_{ct} π {d}_{0} {L}_{w} Δ {v}_{c}^{x - 1} {f}^{y - 1} {a}_{sp}^{z - 1} {t}_{c}}{1000 {C}_{T}} + {t}_{ot} \qquad ( 8 )$$

III. Determining constraint conditions.

In an actual machining process, due to constraints of the lathe itself and limitation of size specifications of blanks or semi-finished products and the like, values of the cutting parameters need to meet the corresponding constraint conditions, specifically:

(1) a cutting speed constraint. The speed of the lathe during machining needs to be between a highest cutting speed and a lowest cutting speed, namely,

$$\frac{π {d}_{0} {n}_{m i n}}{1000} \leq {v}_{c} \leq \frac{π {d}_{0} {n}_{m ax }}{1000} \qquad ( 9 )$$

where nₘᵢₙ and nₘₐₓ respectively represent a minimum value and a maximum value of a spindle rotating speed of machining equipment.

(2) a feed rate constraint. The feed rate ƒ of the lathe during machining needs to be between a maximum feed rate and a minimum feed rate, namely,

ƒₘᵢₙ≤ƒ≤ƒₘₐₓ (10)

where ƒₘᵢₙ and ƒₘₐₓ respectively represent a minimum value and a maximum value of the allowable feed rate of the machining equipment.

(3) a cutting force constraint. Feed resistance of the lathe during machining is less than or equal to a maximum cutting force that a feed mechanism can bear, namely,

C_{F}αₛₚ^{x}ƒ^{y}v_{c}ⁿK_{F}≤Fₘₐₓ (11)

where Fₘₐₓ represents a maximum cutting force, and C_{F}, x, y, n and K_{F} represent coefficients related to a machined workpiece and cutting conditions and can be obtained by checking the cutting handbook for specific situations.

(4) a machining quality requirement. Machining quality is expressed by a roughness of the surface of the machined part herein, namely,

$${R}_{a} = \frac{0.0312 {f}^{2}}{{r}_{ɛ}} \leq {R}_{m ax} \qquad ( 12 )$$

where r_{ε}is a corner radius of the tool, and Rₘₐₓ represents a maximum value required by the roughness of the surface of the part.

(5) A power constraint. Power of the lathe during operation needs to be less than or equal to a maximum cutting power marked on a nameplate of the lathe, namely,

$$\frac{{F}_{c} {v}_{c}}{1000 η} \leq {P}_{m ax} \qquad ( 13 )$$

where η is total power of the lathe, Pₘₐₓ represents the maximum cutting power marked on the nameplate of the lathe, and F_{c} represents the cutting force of the lathe during machining.

By integrating the above analysis, a multi-objective optimization model of cutting parameters can be summarized as follows:

$$\begin{matrix}min \text{:} F ( {v}_{c} , {a}_{sp} , f ) = ( min E , min {T}_{p} ) & ( 14 ) \\ s . t \{ \begin{matrix}\frac{π {d}_{0} {n}_{m i n}}{1000} \leq {v}_{c} \leq \frac{π {d}_{0} {n}_{ma x}}{1000} \\ {f}_{m i n} \leq f \leq {f}_{ma x} \\ {C}_{F} {a}_{xp}^{x} {f}^{y} {v}_{c}^{n} {K}_{F} \leq {F}_{ma x} \\ \frac{0.0312 {f}^{2}}{{r}_{ɛ}} \leq {R}_{ma x} \\ \frac{{F}_{c} {v}_{c}}{1000} \leq η {P}_{ma x} \\ {a}_{p m i n} \leq {a}_{p} \leq {a}_{p ma x}\end{matrix} & ( 15 )\end{matrix}$$

IV. Determining reasonable machining parameters by adopting an improved multi-objective PSO.

For the objective function in formula (14), the aim is to solve minimum machining time and minimum energy consumption so as to achieve the purposes of saving energy and reducing emission. Further, in order to solve the problems of low convergence speed and low solving accuracy in solving the multi-objective function in some algorithms, some improvement measures are adopted to further improve the convergence speed and accuracy so as to obtain more optimal parameter combinations.

The problem studied in the present application is a discrete combination optimization problem, and a particle swarm optimization is a continuous space optimization algorithm, so it is not feasible to directly solve a scheduling problem by using the particle swarm optimization. Therefore, solving the discrete optimization problem by the improved PSO needs the operations such as particle coding, and the basic PSO, particle coding and improvement methods are described one by one below.

4.1 A basic particle swarm optimization.

The particle swarm optimization (PSO) is a new swarm intelligence optimization algorithm based on a swarm evolution algorithm. Each particle in the algorithm represents a potential solution, and the movement direction and distance of the particle are determined by a velocity.

It is assumed that P is a population composed of n particles, and a dimension of a search space is D.V_{id} represents a speed of a particle i in a d-dimension space, X_{id} represents a position of the particle i in the d-dimension space, an individual extreme value is Pᵢ, and a population extreme value is P_{g}. At each iteration, a speed updating formula and a position updating formula of the PSO are as follows:

V_{id}(t+1)=ω(t)V_{id}(t)+cᵢr₁(Pᵢ(t)−X_{id}(t))+c₂r₂(P_{g}(t)−X_{id}(t)) (16)

X_{id}(t+1)=X_{id}(t)+V_{id}(t+1) (17)

where ω(t) is an inertia factor, and is set by adopting a linear decreasing strategy, and expressed as:

$$ω ( t ) = {ω}_{m ax} - \frac{( {ω}_{m ax} - {ω}_{m i n} )}{iter} \times t \qquad ( 18 )$$

where ωₘₐₓ and ωₘᵢₙ represent a maximum value and a minimum value of the inertia factor, d represents the particle dimension, 1≤d≤D, i represents the number of the particles, 1≤i≤n, t and iter are a current iteration number and a maximum iteration number, c₁ and c₂ are nonnegative constants and referred to as acceleration factors, and r₁ and r₂ are random numbers distributed in [0, 1].

4.2 Improvement measures.

(1) Parameter coding

The number of the particles in the population P is set as n, and a position vector of each particle is composed of three parameters of the machining parameters, i.e., the dimension of the position vector of an individual is D=3. The population can be expressed by a matrix of P×D:

$$P ( n \times D ) = [ \begin{matrix}\begin{matrix}{K}_{{v}_{c}}^{1} & {K}_{{a}_{sp}}^{1} & {K}_{f}^{1}\end{matrix} \\ \begin{matrix}{K}_{{v}_{c}}^{2} & {K}_{{a}_{sp}}^{2} & {K}_{f}^{2}\end{matrix} \\ … \\ \begin{matrix}{K}_{{v}_{c}}^{n} & {K}_{{a}_{sp}}^{n} & {K}_{f}^{n}\end{matrix}\end{matrix} ]$$

(2) A random walk method

The present application provides a solution idea to solve the problem of low convergence speed of the basic PSO. After a global optimal solution is found by the PSO, the random walk method is adopted as a local search strategy, so that the algorithm is prevented from stopping searching because the local optimal solution is obtained, and the convergence speed and the solution accuracy of the PSO are improved. The random walk method is an algorithm for finding an optimal solution by utilizing random numbers, the diversity of particles is increased, and the specific expression is as follows:

xᵢ=xᵢ₋₁+λuᵢ₋₁ (19)

where xᵢ represents an approximate minimum value obtained within i−1 steps, λ is a constant and decides the search range, and uᵢ is a unit vector generated at random. The specific process is as follows.

Step 1: P_{g} is an optimal solution found by the PSO. λ=0.5 is a step length, ε=0.05 is a minimum step length, and t is the iteration number.

Step 2: t=1 is set.

Step 3: if t≤10, the following steps are performed:

1). x=P_{g}, a group of random numbers r₁,r₂, . . .,rₙ∈[0,1] are generated, and n is the dimension of the search space. h=(r₁²+r₂²+. . .+rₙ²) is set, and if h>1, random numbers are generated again until h≤1;

2).

$$u = \frac{1}{\sqrt{{r}_{1}^{2} + {r}_{2}^{2} + … {r}_{n}^{2}}} \{ \begin{matrix}{r}_{1} \\ {r}_{2} \\ ⋮ \\ {r}_{n}\end{matrix} \} ;$$

3).x₁=x+λu;

Step 4: if x₁ is superior to P_{g}, P_{g}=x₁ and t=t+1, Step 3 is performed again;

Step 5: λ=λ/2 is set, and if λ>ε, Step 2 is performed again, otherwise, P_{g} is output.

(3) Non-dominated sorting and crowding distance sorting

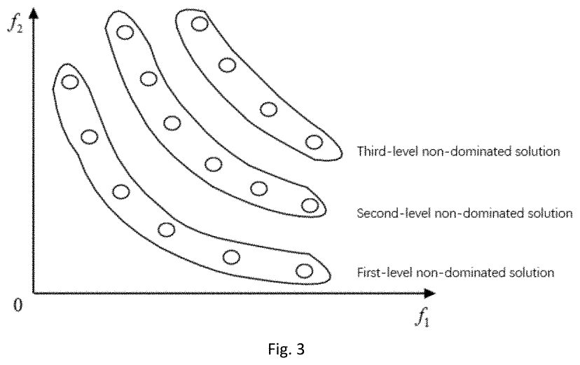

The non-dominated sorting and crowding distance strategies in a non-dominated sorting genetic algorithm are selected, and individuals of the optimal solution are selected from all the individual particles. The idea is as follows: first, the individuals of all non-dominated optimal solutions in the population are determined and placed in a first level, and the individuals continue to be ranked according to dominating relationships in remaining populations. Next, the above process is repeated until all individuals in a solution set are ranked. A hierarchical schematic diagram of non-dominated solutions is as shown in FIG. 3.

A crowding distance Dᵢ is the sum of Euclidean distances between the particle i and all particles within the same non-dominated solution level. The crowding distance of the particle i can be calculated according to the following formula:

$${D}_{i} = {\sum }_{j = 1}^{l} \sqrt{{\sum }_{h = 1}^{p} {( {f}_{i}^{h} - {f}_{j}^{h} )}^{2 }} , i , j ∈ F ( s ) , j \neq i \qquad ( 20 )$$

where Dᵢ represents the crowding distance of the particles, F(s) represents a set of all particles with the non-dominated solution level as s, ƒⱼ^{h} represents a h^{th} objective function of a j^{th} particle, there are p objective functions, and l represents the number of particles in the set F(s).

(4) An improved algorithm process

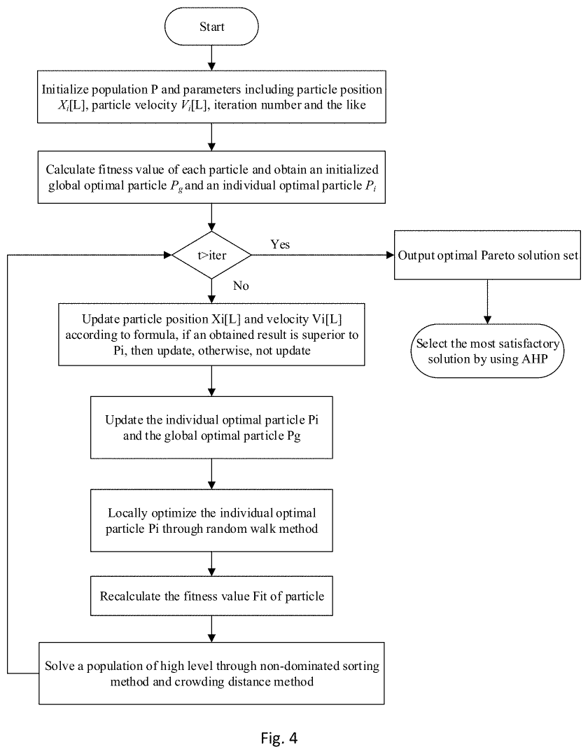

In conclusion, a flow diagram of an improved algorithm according to the present disclosure is as shown in FIG. 4.

According to the analysis of the solving process of an RWA-MOPSO hybrid algorithm, the specific steps for solving the machining parameter solution set by the improved algorithm are provided as follows:

Step 1: the population and the parameters are initialized;

Step 2: a fitness value of each particle is calculated, and a global optimal particle and an individual optimal particle are initialized;

Step 3: the particles are updated according to the formula (16) and the formula (17);

Step 4: the individual optimal particle Pᵢ and the global optimal particle P_{g} are updated;

Step 5: the individual optimal particle is locally optimized through the random walk method;

Step 7: the fitness value of each particle is calculated and compared, and whether the individual extreme value Pᵢ and the global extreme value P_{g} of the population need to be updated is judged;

Step 8: a population of the high level is solved through a non-dominated sorting method and a crowding distance method;

Step 9: whether the current iteration number is greater than a specified value or not is judged, if yes, the next step Step 10 is performed, and an optimal solution set is output, and if no, the third step Step 3 is performed; and

Step 10: the algorithm is ended, and an optimal Pareto solution set is output.

4.3 Optimization decision based on AHP hierarchical analysis

After a Pareto solution set of the energy-saving optimization problem is solved by using the optimized RWA-MOPSO hybrid algorithm, a machining parameter needs to be objectively selected from the solution set as an optimal solution. According to the method, an analytic hierarchy process is adopted, the importance of an energy-saving index is evaluated according to an expert system, an optimal scheme is selected, and the interference of human factors is avoided.

The basic idea of using a AHP decision method is to divide the complex solving problem into different levels, compare every two sub-objectives at the lowest level to obtain a weight coefficient of each sub-objective, then calculate a weight coefficient of each scheme to a total scheduling objective, and select the scheme with the largest weight coefficient as a final scheme. AHP decision effectively combines the advantages of quantitative and qualitative analysis, needs less information in a decision process, is short in consumed time, simple and easy in realization and the like, and is widely applied to discrete manufacturing production management.

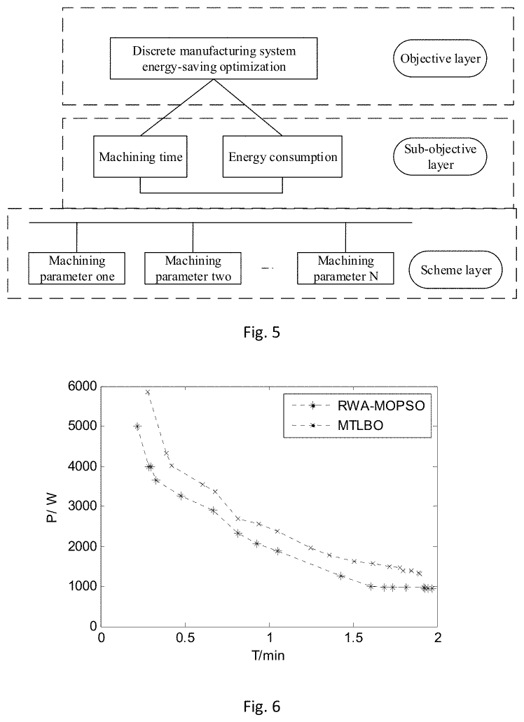

For the decision of the final scheme of optimization problem, a multi-level hierarchical structure of AHP is usually divided into three parts including an objective layer, a sub-objective layer and a scheme layer. The objective layer is the objective of energy-saving optimization; the sub-objective layer is aimed at each selected sub-objective to be considered, and the machining time and energy consumption are those needs to be considered in this paper; the scheme layer is a Pareto solution set obtained by the multi-objective algorithm, and a specific hierarchical structure model is as shown in FIG. 5.

The importance of each objective in decision is machining time and product energy consumption in sequence. The numbers 1-9 are used to represent important degrees between every two objective functions to obtain a judgment matrix:

$$A = [ \begin{matrix} & E & {T}_{p} \\ E & 1 & 1 / 5 \\ {T}_{p} & 5 & 1\end{matrix} ] \qquad ( 21 )$$

The units (dimensions) of each index of the sub-objective layer are different, for example, the unit of machining time is second, the unit of energy consumption is watt, there is no uniform reference for selection of optimal machining parameters, and the machining time and the energy consumption cannot be compared. Therefore, before the optimal machining parameter set is selected, one-step normalization processing is carried out, so that all indexes are in a same order of magnitude for facilitating comparison. The specific method comprises the following steps: deviation standardization is carried out, and linear transformation is carried out on data of the matrix A, so

$${b}_{ij} = \frac{{a}_{j}^{m ax} - {a}_{ij}}{{a}_{j}^{ma x} - {a}_{j}^{m i n}} \qquad ( 22 )$$

transformed data bᵢⱼ is summed according to a row:

$${{W}^{⋮}}_{j} = {\sum }_{i = 1}^{p} {b}_{ij} , q \geq j \geq 1 \qquad ( 23 )$$

normalization is performed on sum vectors:

$${W}_{j} = \frac{{{W}^{⋮}}_{j}}{{\sum }_{j = 1}^{q} {{W}^{⋮}}_{j}} \qquad ( 24 )$$

where αⱼ^{min} and αⱼ^{min} are respectively a maximum value and a minimum value of a corresponding j column of the judgment matrix A, p is the number of evaluation schemes, q is the number of indexes, i=1,2,L p, j=1,2,L,q; and αᵢⱼ is a value of an index in the Pareto scheme; a decision matrix B=(bᵢⱼ)_{p×q} of the scheme can be obtained through the above formula, thus an optimal satisfaction degree matrix is calculated by multiplying the decision matrix B by a weight vector w^{T}=[W₁,W₂,L,W_{q}], namely

$$D = ( {D}_{i} ) = {BW}^{T} = {\sum }_{j = 1}^{q} {b}_{ij} {W}_{j} ,$$

and an evaluation scheme satisfaction degree matrix D=(Dᵢ)ₚ=[D₁D₂L Dₚ]^{T} is obtained.

4.4 Simulation analysis

In order to verify that the machining parameters obtained by the method are more reasonable, a simulation experiment is particularly carried out as follows.

4.4.1 Experiment conditions

Taking single machine equipment in a bearing grinding machine manufacturing system as an example, data required for the simulation experiment is collected and acquired on a numerically controlled lathe, and the specific parameters of the lathe are shown in Table 5.

TABLE 5
Specification Parameters of Numerically Controlled Lathe

| | Numerical |
|---|---|
| Name | Value |
| Lowest spindle rotating speed (r/min) | 80 |
| Highest spindle rotating speed (r/min) | 1400 |
| Smallest feed rate (mm/r) | 0.1 |
| Highest feed rate (mm/r) | 3.5 |
| Largest cutting force (N) | 900 |
| Highest effective cutting power (KW) | 15 |

In addition, the material of the machined part is 45 # steel bars, the quality standard R_{α} of the machined part is less than or equal to 6.4 μm, the cutting depth of the part αₛₚ=1 mm, and cutting fluid is used in an experimental process. Looking for the cutting handbook, the tool requirements are as follows: the material is a hard alloy material, the cutting edge angle is 5°, the main deviation angle is 45°, the rake angle is 20°, the corner radius is r_{ε}=0.8 mm, and the service life of the tool is 64136h, and the parameters related to the material of the part and the machining tool are shown in table 6.

TABLE 6
Cutting Force Parameters

| x | 5 | x_{FC} | 1.0 |
|---|---|---|---|
| y | 1.75 | y_{FC} | 0.5 |
| z | 0.75 | n_{FC} | −0.4 |
| C_{FC} | 2880 | K_{FC} | 1 |

4.4.2 Optimization result and analysis

According to the algorithm flow diagram, the simulation experiment is carried out under MATLAB2010b and runs on a Windows 7 operating system with single-core Intel Courier CPU and 2 GB memory. Simulation parameters are set as follows: ω=1.3, c₁=1.6, and c₂=1.6, the maximum value of the iteration number is 200, and the size of the initial population P is 60.

The final Pareto front solution obtained by the algorithm is as shown in FIG. 6, where the first group and the last group of solutions are two limit values of an energy consumption optimization objective and a machining time optimization objective respectively, and the others are between the two limit values.

In order to verify the effectiveness and superiority of the improved algorithm, the improved algorithm is compared with an MTLBO method provided by Zhou Zhiheng, Zhang Chaoyong, Xie Yang et al. in the article Cutting Parameters Optimization for Processing Energy and Efficiency in CNC Lathe [J]. Computer integrated manufacturing system, 2015, 21 (9): 2411-2417, and with other conditions being the same, the Pareto front solutions of the two algorithms are obtained, as shown in FIG. 6. The Pareto front of the MTLBO method is all above the improved RWA-MOPSO algorithm provided by the present application.

Then, the analytic hierarchy process AHP is used to select the optimal machining parameters objectively and practically from the Pareto front solutions. Through calculation, a weight coefficient W^{T}=(0.167,0.833) is obtained,

$$D = ( {D}_{i} ) = {BW}^{T} = {\sum }_{j = 1}^{q} {b}_{ij} {W}_{j}$$

is calculated, and the evaluation scheme satisfaction degree matrix (Dᵢ)ₚ is obtained. D_{L}=max D=D₉ is taken, namely the machining parameters of a ninth group are most reasonable. The corresponding machining parameters are n=800r/min, ƒ=0.20 mm/r, and αₛₚ=0.5 mm, and in this case, the corresponding energy consumption is 1864 W and the machining time is 58 s.

The algorithm of the present application is randomly tested 20 times, and the average values and corresponding machining parameters are compared with those obtained by the MTLBO method provided by Zhou Zhiheng, Zhang Chaoyong, Xie Yang et al. in the article Cutting Parameters Optimization for Processing Energy and Efficiency in CNC Lathe [J]. Computer integrated manufacturing system, 2015, 21 (9): 2411-2417, as shown in Table 7. MTLBO represents a multi-objective teaching and learning optimization algorithm, RWA-MOPSO represents the improved algorithm provided by the present application, and an empirical method refers to that machining parameters are selected by an operator according to own multi-year machining experience and a reference handbook.

TABLE 7
Comparison Between Algorithm Provided by Present
Application and Other Algorithms

| | | | | | Empirical | |
|---|---|---|---|---|---|---|
| Algorithm | MTLBO | | RWA-MOPSO | | method | |
| Average | 65 s/1964 w | | 58 s/1853 w | | 75 s/2200 w | |
| Value | | | | | | |
| n | 900 | r/min | 800 | r/min | 1200 | r/min |
| f | 0.19 | mm/r | 0.25 | mm/r | 0.16 | mm/r |
| aₛₚ | 0.5 | mm | 0.5 | mm | 0.5 | mm |

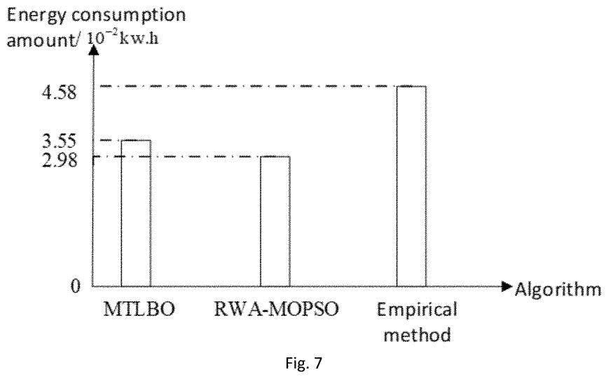

It can be seen from Table 7 that compared with another two methods, the energy consumption amount and energy-saving amount of the algorithm according to the present application are as shown in FIG. 7 and Table 8.

TABLE 8
Energy-saving Percentage of Algorithm of Present Application
Compared with Other Algorithms

| | | Empirical |
|---|---|---|
| Algorithm | MTLBO | method |
| Energy-saving | 15.8% | 34.9% |
| percentage | | |

The present disclosure provides the system and a method for predicting the energy consumption in a numerically controlled lathe turning process based on a decision tree, which mainly include how to acquire and update the turning parameter training sample set and the attribute set, and how to generate the decision tree prediction model for energy consumption and provide a correction scheme for the prediction result. The energy consumption in the numerically controlled lathe turning process is predicted based on a large amount of historical data generated in the turning process, and limit of specific workshop environmental factors such as the lathe types and the workpiece machining methods on the traditional energy consumption prediction algorithm is broken through; meanwhile, the influence of various factors on the turning energy consumption of the numerically controlled lathe is fully considered, the quantitative relationship between the turning energy consumption and the turning parameters is obtained by utilizing the decision tree algorithm in the data mining technology, and then the quantitative relationship is combined with the self-correction module to correct the preliminary prediction result, so that the energy consumption in the turning process of the numerically controlled lathe is calculated in advance for guiding the actual machining process. In addition, the model and the historical turning parameter database can be continuously updated according to actual situations, so that the prediction precision of the prediction model is continuously improved, and an operator can select more reasonable turning parameters, thus finally helping enterprises to improve the machining efficiency.

Some of the steps in the embodiments of the present disclosure may be implemented through software, and corresponding software programs may be stored in a readable storage medium, such as an optical disk or a hard disk.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A method comprising:
computing, by a computer, an objective function representing energy consumption in a turning process of a lathe, based on a characteristic of the turning process; and
reconfiguring the turning process by adjusting the characteristic of the turning process until a termination condition is satisfied;
wherein the computing of the objective function comprises:
obtaining a training data set comprising values of the characteristic and respectively values of the energy consumption corresponding thereto;
processing the training data set by discretizing the values of the characteristic;
establishing a decision tree model based on the processed training set; and
determining the energy consumption based on the characteristic using the decision tree model.

17. The method of claim 16, wherein discretizing the values of the characteristic comprises:
sorting the values of the characteristic;
computing mean values of each adjacent pair of the sorted values of the characteristic;
computing an information gain ratio at each of the mean values; and
selecting one of the mean values at which the information gain ratio is at a maximum.

18. The method of claim 16, wherein the computing of the objective function further comprises validating the decision tree model using a validation data set comprising values of the characteristic and respectively values of the energy consumption corresponding thereto.

19. The method of claim 16, wherein the characteristic of the turning process is selected from a group consisting of a cutting speed, a cutting depth and a feed rate.

20. The method of claim 16, wherein the termination condition is that the energy consumption is minimized.

21. The method of claim 16, wherein the objective function further represents a duration of the turning process.

22. The method of claim 21, wherein the termination condition is that the energy consumption and the duration are minimized.

23. The method of claim 16, wherein the characteristic of the turning process is under a constraint.

24. The method of claim 16, wherein the reconfiguring of the turning process comprises using particle swarm optimization (PSO).

25. The method of claim 24, wherein the reconfiguring of the turning process further comprises:
after a solution of the characteristic is found using the PSO, further optimizing the solution by performing random walk around the solution with iteratively decreasing step lengths.

26. The method of claim 16, wherein the reconfiguring of the turning process comprises using non-dominated sorting or crowding distance sorting.

27. The method of claim 16, wherein the reconfiguring of the turning process comprises using an analytic hierarchy process (AHP).

28. A computer program product comprising a computer non-transitory readable medium having instructions recorded thereon, the instructions when executed by a computer implementing the method of claim 16.

29. A lathe comprising the computer program product of claim 28.
